(19) United States
(12) Patent Application Publication
(10) Pub. No.: US 2008/0306802 A1
(43) Pub. Date: Dec. 11, 2008

(54) System and Method for Distribution of Campaign Resources

(75) Inventor: Matthew L. Ginsberg, Eugene, OR (US)

Correspondence Address: FENWICK & WEST LLP, SILICON VALLEY CENTER, 801 CALIFORNIA STREET, MOUNTAIN VIEW, CA, 94041, US

(73) Assignee: On Time Systems Inc., Eugene, OR (US)

(21) Appl. No.: 12/131,653

(22) Filed: Jun. 2, 2008

Related U.S. Application Data
(60) Provisional application No. 60/941,956, filed on Jun. 5, 2007.

(51) Int. Cl. G06Q 10/00; G06Q 50/00

(52) U.S. Cl. 705/8; 705/10

(57) ABSTRACT

A system and method for distribution of campaign resources generates proposed allocations of resources, predicts electoral results based on such proposals, and selects strategies based on predetermined metrics. Both the activities of a protagonist (e.g., candidate) and of one or more opponents are considered. A campaign model considers polling impacts from the proposed allocations as well as electoral projections based on polling. Results are presented to a user via maps and timelines, as well as by alphanumeric data.

### RELATED APPLICATION

This application claims the priority of U.S. Provisional Application No. 60,941,956, filed Jun. 5, 2007.

### BACKGROUND

1. Field of Art

The present invention generally relates to the management of resources in campaigns, and more specifically, to the management of both cash available for advertising expenditures and personal appearances in political campaigns where the outcome is determined by some method other than a simple counting of the popular vote.

2. Description of the Related Art

Political campaigns currently allocate resources using informal techniques. These techniques include the identification of so-called “battleground” states in which both competing candidates are felt to be competitive, and the subsequent assignment of campaign resources to these states.

Campaign resources include both money and the possibility of appearances by candidates, their spouses or other family members, and other closely associated individuals.

The resources are generally assigned to battleground states in a relatively ad hoc fashion, with the candidates attempting to compete effectively in all states in which they are competitive. As the campaign continues and some states appear to be decided, resources are withdrawn from these states. If other states become competitive, resources are added.

Quantitative information is gradually becoming available regarding the impact that these resources and their expenditure actually have on the electorate. In general, it is assumed that the electoral impact of campaign advertising or candidate appearances can be evaluated by first measuring the impact on weekly or other short-term polling data, and then by separately measuring the correlation between such polling data and the actions of the electorate on election day. These models have gradually become more sophisticated as the quality of the underlying quantitative information has improved.

In spite of the public availability of these quantitative models of election behavior, there has been no attempt to incorporate these models into campaign activities. No quantitative methods exist to ensure that campaigns expend their limited resources in ways that maximize their chances of electoral success.

### SUMMARY

As disclosed herein, an optimization system is used to automatically determine optimal assignments of campaign resources to states or other regions. In one embodiment, it is assumed that the political opponent will act in accordance with historical trends, identifying battleground regions and allocating resources to them. In other embodiments, the political opponent can be assumed to distribute resources uniformly among voters, or to be optimizing as well.

In one embodiment, political action committees (PACs) are assumed not to play a significant role in the election in question. In other embodiments, PACs are assumed to play a significant role and their actions are modeled according to historical norms, by using optimization, or in other ways.

In one embodiment, the political resources being allocated include television advertisement budgets and candidate appearances. In other embodiments, these resources include other forms of paid exposure, such as direct mail, telephone, personal contact, or get-out-the-vote drives. In still other embodiments, these resources also include appearances by candidates' spouses, family members, or supporters.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description, when taken in conjunction with the accompanying drawings, in which:

FIG. 1 is a flowchart indicating the high-level steps performed to produce the polling model, according to one embodiment.

FIG. 2 is a flowchart indicating the high-level steps performed to produce the electoral model, according to one embodiment.

FIG. 3 is a flowchart indicating the high-level steps performed to produce the campaign model, according to one embodiment.

FIG. 4 is a flowchart illustrating the overall high-level steps performed, according to one embodiment.

FIG. 5 illustrates input screens used to collect data needed by the polling, electoral and campaign models in one embodiment.

FIG. 6 illustrates an output screen used to display optimal resource allocation in one embodiment.

FIG. 7 is a high-level block diagram illustrating a computer system for implementing a preferred embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

### System Architecture

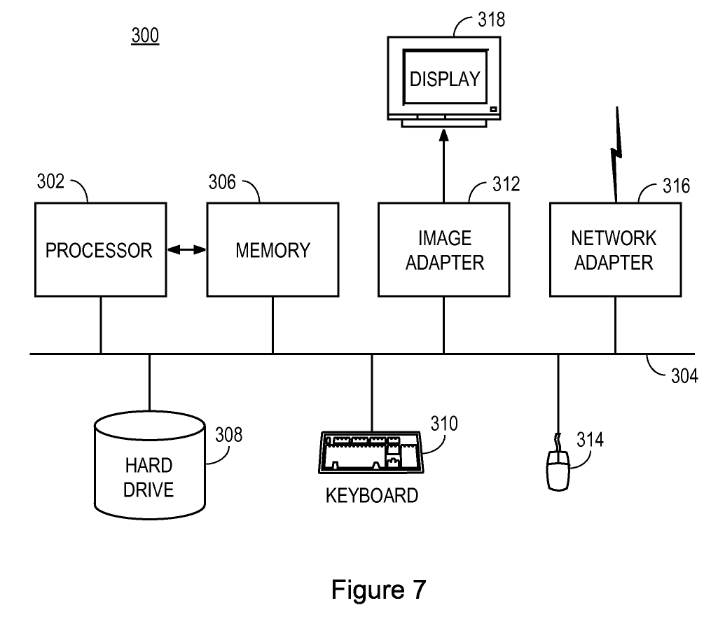

FIG. 7 is a high-level block diagram illustrating a computer system 300 for computing resource allocations as described herein. In a preferred embodiment, a conventional computer programmed for operation as described herein is used to implement computer system 300. Processor 302 is conventionally coupled to memory 306 and bus 304. For applications in which higher performance is required, multiple processors 302 are employed. Also coupled to the bus 304 are memory 306, storage device 308, keyboard 310, graphics adapter 312, pointing device 314, and network adapter 316. Display 318 is coupled to the graphics adapter 312.

In a typical embodiment, processor 302 is any general or specific purpose processor such as an INTEL 386 compatible central processing unit (CPU). Storage device 308 is any device capable of holding large amounts of data, like a hard drive, compact disc read-only memory (CD-ROM), digital versatile disc (DVD) or other removable storage device. Memory 306 holds instructions and data used by the processor 302. The pointing device 314, such as a mouse, track ball, light pen, touch-sensitive display, is used in combination with the keyboard 310 to input data into the computer system 300. The graphics adapter 312 displays images and other information on the display 318. The network adapter 316 couples the computer system 300 to the user's network environment, such as a local or wide area network (not shown).

A program for computing and displaying optimal resource allocations according to one embodiment of the present invention is preferably stored on the storage device 308, loaded from memory 306, and executed on the processor 302. Alternatively, hardware or software modules are stored elsewhere within the computer system 300 for performing actions as described herein.

The results of the computation are output to the display 318, and, as desired, to additional output devices and output formats (not shown), including, for example, printers, fax devices, and image or printer files. Additionally, if desired they are passed as input to other software processes, such as those for handling other aspects of campaign management.

### Exemplary Results

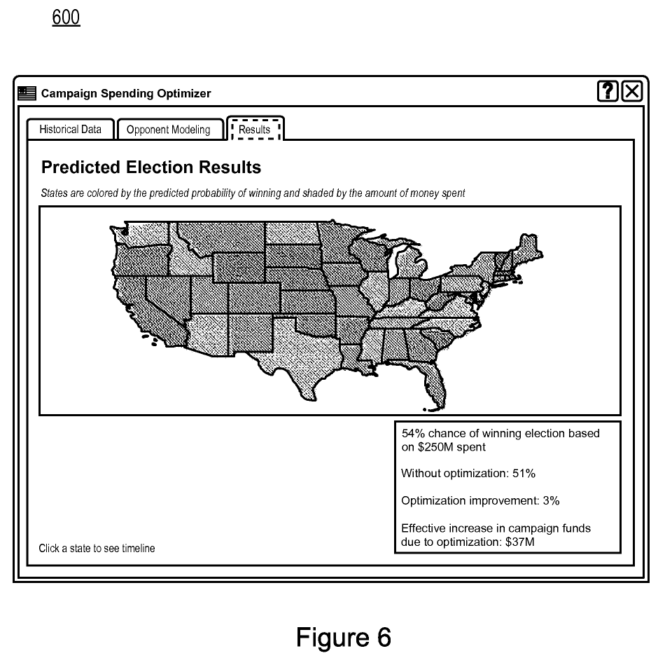

Referring now to FIG. 6, a map graphic 600 produced in accordance with one embodiment is illustrated, in which shading is used to indicate the amount of money spent on campaign advertising in any particular state. By clicking on a state, detailed information can be obtained giving specific resource allocations over time.

In the embodiment displayed, shading indicates the amount of money spent on advertising in any particular state. In other embodiments, shading is used to indicate the number of candidate appearances targeted for the state in question; the allocation of other campaign resources is displayed using other graphical elements. In still other embodiments, information regarding resource allocation is displayed via a table, via a database, via an Excel spreadsheet, or by other means.

### Method of Operation

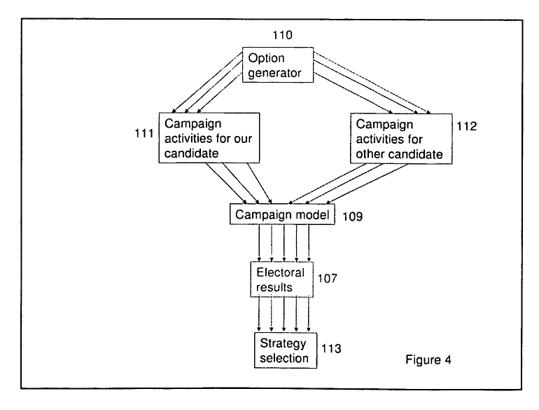

FIG. 4 illustrates, in flowchart form, one example of steps taken in order to produce a graph, e.g., map graphic 600, according to a preferred embodiment.

In the first step, an option generator 110 generates possible resource allocation strategies 111 for our candidate and resource allocation strategies 112 for the opposing candidate or candidates. In a preferred embodiment, the option generator 110 accepts guidance from the user regarding likely activities of political action committees on both sides, likely behavior of our opponent(s), the projected results of other possible resource allocations and will generate new allocations that seem able or likely to improve on the performance of the allocations that have been examined thus far. In a preferred embodiment, this is done by generating a set of new allocations that is similar to but significantly different than one of the best resource allocations that has already been considered. As an example, the new resource allocations could be all resource allocations that differ from the best allocation produced thus far by at least 1% in at least one state or other political district but by no more than 5% in any state or political district. In other embodiments, the option generator uses simulated annealing to ensure that a wide range of options is considered, uses a complete analysis of the search space coupled with game-tree mechanisms such as alpha-beta pruning, or applies other known techniques for proposing possible allocations.

The resource allocation options produced by the option generator 110 are identified as strategies for our campaign 111 or for our opponent's or opponents' 112. These options are then passed as inputs to the campaign model 109 and are evaluated to obtain likely electoral results 107. In one embodiment, these results are used to restrict or otherwise inform the further activity of the option generator 110; when the procedure is complete the strategy selector 113 chooses the strategy that is deemed best according to some predefined metric. In a preferred embodiment, the process terminates when the option generator fails to generate a new option for consideration and the strategy selected is that strategy with the highest probability of winning. In other embodiments, the termination condition is related to a timeout or to user input. In an embodiment to address one particular situation, the selected strategy is the one that optimally combines probability of winning with a desire to allocate resources in states that are felt to be important in intangible ways, such as the presence of large campaign donors or having aligned candidates for local office.

Finally, the selected strategy is presented to the user. In a preferred embodiment, the presentation uses visual map data to indicate where resources should be allocated, with the user able to obtain quantitative textual information by clicking on any particular state. Again in a preferred embodiment, this textual information includes not just the total amount to be spent, but the proposed timeline by which the resources are allocated.

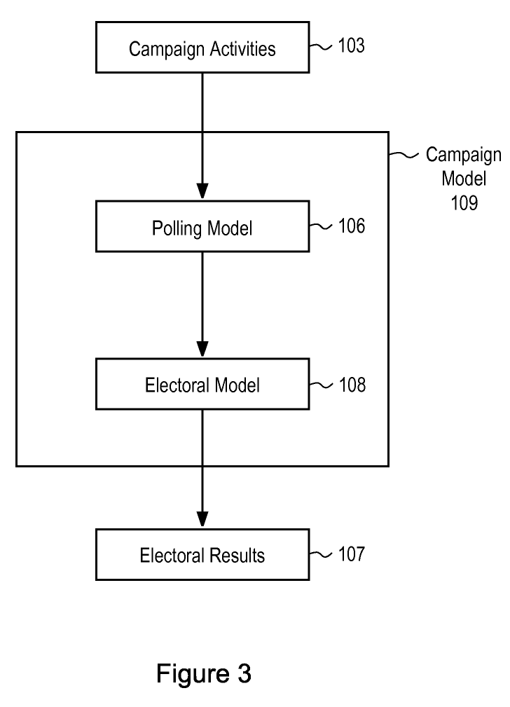

As shown in FIG. 3, the campaign model 109 operates by analyzing campaign activities 103, 111 or 112 using first a polling model 106 that identifies the impact of these campaign activities on likely polling results, and then an electoral model 108 that projects electoral results from polling information.

FIG. 1 shows the operation of the polling model 106 in one embodiment. The polling model expects historical data as input, consisting of polling data 104, and campaign activity data 103 in terms of expenditure information 101 and candidate appearance information 102. A multivariate analysis 105 is performed to identify the dependency of the polling results 104 on the campaign activities 103, and the results of this multivariate analysis are the polling model 106. In a preferred embodiment, the multivariate analysis engine 105 analyzes its inputs using linear regression to construct a general model. In other embodiments, this analysis is performed using genetic algorithms, time-series modeling, and other known techniques as may be desirable in any particular situation.

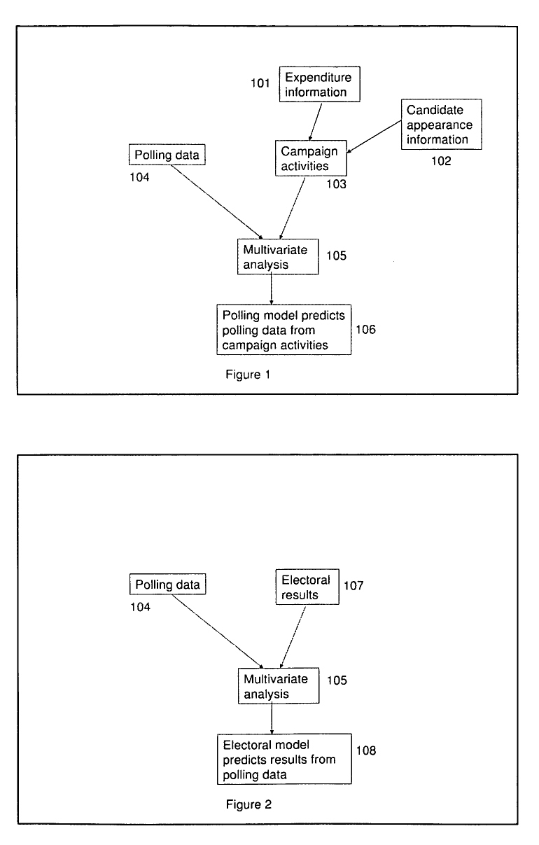

FIG. 2 shows the construction of the electoral model 108 in one embodiment. The electoral model expects historical data as input, consisting of polling data 104 and electoral results 107. A multivariate analysis 105 is performed to identify the dependency of the electoral results 107 on the polling data 104, and the results of this multivariate analysis are the electoral model 108. In a preferred embodiment, the multivariate analysis engine analyzes its inputs using linear regression to construct a general model. In other embodiments, this analysis is performed using genetic algorithms, time-series modeling, and other known techniques as may be desirable in any particular situation.

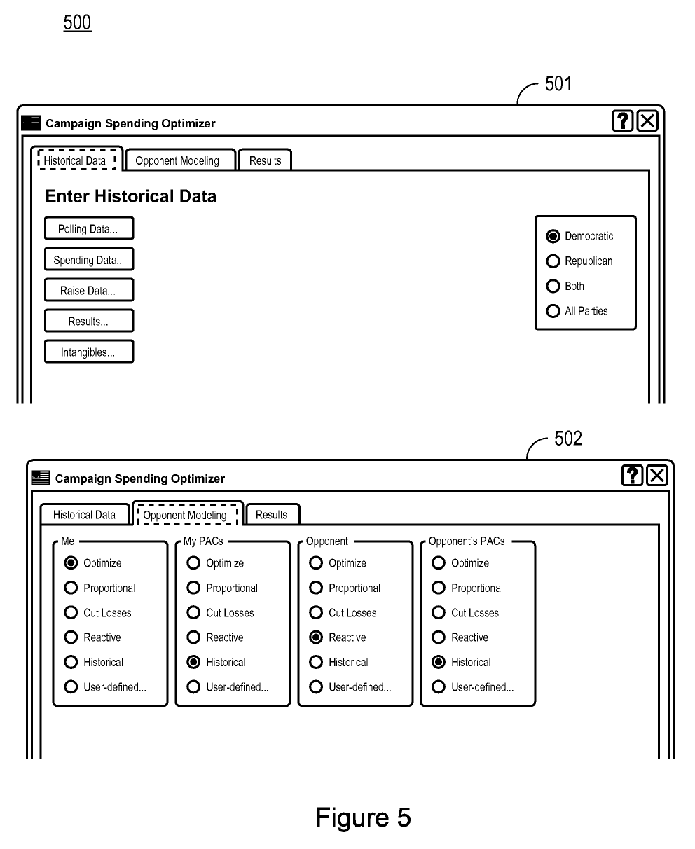

Referring now to FIG. 5, there is shown an exemplary data input user interface 500 including an historical data portion 501 and an opponent modeling portion 502. In one embodiment, the historical data 501 is seen to include polling data 104, campaign spending data 101, and electoral results 107. Other embodiments can be seen to include other factors such as campaign intangibles and fundraising information. These other factors are included in other embodiments of the polling model 106 or electoral model 108. In one embodiment, the opponent modeling portion 502 indicates resource allocation strategies for both our candidate and our opponent(s), and PACs supporting and opposing our candidate. Those strategies include, in various embodiments, optimization, allocation proportional to the number of voters reached, a “cut loss” strategy where states that are no longer competitive are ignored, a reactive strategy that attempts to match the activities of the other candidate(s) in the race, a historical strategy based on resource allocations in previous elections, and different strategies identified by the user for any particular situation.

One of skill in the art will realize that the invention is not limited to providing proposed allocations of campaign funding and candidate appearances, but could equally well be applied to any other resource that a political campaign is attempting to allocate. The invention is similarly not limited to providing output to a display such as a monitor, but can display a graph by any action that results, directly or proximately, in a visual image, such as outputting to a printer, to a fax, to an image file, or to a file containing printer description language data.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the words “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for allocating campaign resources through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A resource allocation system, comprising:
an option generator configured to accept input from a user, the input including at least one of predicted activities of a protagonist, predicted activities of an action group, and predicted activities of an opponent, the option generator producing therefrom a plurality of potential activities of at least one of the protagonist, the action group and the opponent;
a campaign model subsystem operatively coupled to the option generator and taking as inputs a subset of the plurality of potential activities and producing as output likely campaign results for each of the subset of the plurality of potential activities; and
a strategy selector, the strategy selector operationally coupled to the campaign model subsystem, the strategy selector taking as inputs the likely campaign results for each of the plurality of potential activities and, responsive thereto, selecting a strategy.

2. A system as in claim 1, wherein a first subset of the inputs to the option generator relate to the protagonist.

3. A system as in claim 1, wherein a second subset of the inputs to the option generator relate to the opponent.

4. A system as in claim 1, wherein the option generator is configured to use at least one of simulated annealing and alpha-beta pruning in producing the plurality of potential activities.

5. A system as in claim 1, wherein the option generator is further configured to accept as input the likely campaign results produced by the campaign model subsystem.

6. A system as in claim 1, wherein the strategy selector is further configured to select the strategy responsive to a predetermined metric.

7. A system as in claim 6, wherein the predetermined metric includes at least one of probability of winning, a cut-loss threshold, opponent activity matching, historical allocations, selection of resource utilization in areas having large populations, selection of resource utilization in areas having large donors, and selection of resource utilization in areas having aligned candidates.

8. A system as in claim 1, wherein the strategy includes an allocation of resources, the system further comprising a user interface presenting at least one of a map indicative of locations where the resources should be allocated and a timeline for allocating the resources at said locations.

9. A system as in claim 1, wherein the campaign model subsystem is configured to include a polling model and an electoral model, the polling model configured to identify an impact on polling results from the proposed allocation improvements, and an electoral model configured to project electoral results based on said polling results.

10. A system as in claim 9, wherein at least one of the electoral model and the polling model includes a multivariate analysis engine, the multivariate analysis engine including at least one of a linear regression processor, a genetic algorithm processor, and a time series modeling processor.

11. A method of allocating resources, comprising:
generating a plurality of potential activities of at least one of a protagonist, an action group and an opponent, responsive to inputs from a user, the inputs including at least one of predicted activities of the protagonist, predicted activities of the action group, and predicted activities of the opponent;
predicting likely campaign results for each of a subset of the plurality of proposed potential activities; and
selecting a strategy responsive to the likely campaign results for each of the plurality of potential activities.

12. A method as in claim 11, wherein a first subset of the inputs relate to the protagonist.

13. A method as in claim 11, wherein a second subset of the inputs relate to the opponent.

14. A method as in claim 11, wherein the generating includes at least one of simulated annealing and alpha-beta pruning in producing the plurality of potential activities.

15. A method as in claim 11, wherein the generating further includes accepting as input the likely campaign results.

16. A method as in claim 11, wherein the selecting is responsive to a predetermined metric.

17. A method as in claim 16, wherein the predetermined metric includes at least one of probability of winning, a cut-loss threshold, opponent activity matching, historical allocations, selection of resource utilization in areas having large populations, selection of resource utilization in areas having large donors, and selection of resource utilization in areas having aligned candidates.

18. A method as in claim 11, wherein the strategy includes an allocation of resources, the method further comprising presenting at least one of a map indicative of locations where the resources should be allocated and a timeline for allocating the resources at said locations.

19. A method as in claim 11, wherein predicting likely campaign results includes identifying an impact on polling results from the proposed allocation improvements, and projecting electoral results based on said polling results.

20. A method as in claim 19, wherein at least one of said identifying an impact and projecting electoral results includes using multivariate analysis, the multivariate analysis including at least one of linear regression, genetic algorithm processing, and time series modeling.

21. A computer program product for use in conjunction with a computer system, the computer program product comprising a computer readable storage medium and a computer program mechanism embedded therein, the computer program mechanism comprising:
instructions for generating a plurality of potential activities of at least one of a protagonist, an action group and an opponent, responsive to inputs from a user, the inputs including at least one of predicted activities of the protagonist, predicted activities of the action group, and predicted activities of the opponent;
instructions for predicting likely campaign results for each of a subset of the plurality of proposed potential activities; and
instructions for selecting a strategy responsive to the likely campaign results for each of the plurality of potential activities.

22. A computer program product as in claim 21, wherein a first subset of the inputs relate to the protagonist.

23. A computer program product as in claim 21, wherein a second subset of the inputs relate to the opponent.

24. A computer program product as in claim 21, wherein the generating includes at least one of simulated annealing and alpha-beta pruning in producing the plurality of potential activities.

25. A computer program product as in claim 21, wherein the generating further includes accepting as input the likely campaign results.

26. A computer program product as in claim 21, wherein the selecting is responsive to a predetermined metric.

27. A computer program product as in claim 26, wherein the predetermined metric includes at least one of probability of winning, a cut-loss threshold, opponent activity matching, historical allocations, selection of resource utilization in areas having large populations, selection of resource utilization in areas having large donors, and selection of resource utilization in areas having aligned candidates.

28. A computer program product as in claim 21, wherein the strategy includes an allocation of resources, the further comprising instructions for presenting at least one of a map indicative of locations where the resources should be allocated and a timeline for allocating the resources at said locations.

29. A computer program product as in claim 21, wherein predicting likely campaign results includes identifying an impact on polling results from the proposed allocation improvements, and projecting electoral results based on said polling results.

30. A computer program product as in claim 29, wherein at least one of said identifying an impact and projecting electoral results includes using multivariate analysis, the multivariate analysis including at least one of linear regression, a genetic algorithm processing, and time series modeling.
